(19) United States
(12) Patent Application Publication
(10) Pub. No.: US 2024/0314886 A1
(43) Pub. Date: Sep. 19, 2024

(54) METHOD FOR SLICE RESOURCE RELEASE

(71) Applicant: ZTE Corporation, Shenzhen (CN)

(72) Inventors: Shuang LIANG, Shenzhen (CN); Menghan WANG, Shenzhen (CN); Jinguo ZHU, Shenzhen (CN); Xiaojian YAN, Shenzhen (CN)

(21) Appl. No.: 18/616,901

(22) Filed: Mar. 26, 2024

Related U.S. Application Data
(63) Continuation of application No. PCT/CN2022/073484, filed on Jan. 24, 2022.

(51) Int. Cl. H04W 76/30; H04W 8/20; H04W 48/18

(52) U.S. Cl. CPC H04W 76/30; H04W 8/20; H04W 48/18

(57) ABSTRACT

A wireless communication method is disclosed. The method comprises: receiving, by a first policy control node from one or more network slice access control nodes, a first notification corresponding to a number of Protocol Data Unit, PDU, sessions in association with a network slice, wherein the first notification indicates the network slice is overloaded; and releasing, by the first policy control node, one or more of the PDU sessions of the network slice in response to the network slice being overloaded.

This application is a continuation Application of International Patent Application No. PCT/CN2022/073484, filed on Jan. 24, 2022 and entitled “METHOD FOR SLICE RESOURCE RELEASE,” the entirety of which is incorporated by reference.

This document is directed generally to wireless communications, and in particular to 5^{th} generation (5G) communications.

When a use equipment (UE) initiates to transfer data for an application, the UE matches the application with the URSP (UE Route Selection Policy) or the UE Local Configuration. When a Single-Network Slice Selection Assistant Information (S-NSSAI) is matched, the UE may initiate a registration procedure to request the S-NSSAI included in the requested Network Slice Selection Assistant Information (NSSAI). Upon successful registration with allowed NSSAI including the S-NSSAI, the UE may request a Protocol Data Unit (PDU) session establishment procedure with the S-NSSAI.

After the application is terminated and the PDU session may not be used by the other application, it is for the UE implementation to maintain the PDU session or release the PDU session. In case that the slice resource is limited and the PDU session is maintained, this may cause additional UEs to fail to register this S-NSSAI and request a S-NSSAI for a PDU session when Network Slice Admission Control (NSAC) is deployed.

This document relates to methods for slice resource release, devices thereof and systems thereof.

The present disclosure relates to a wireless communication method comprising: receiving, by a first policy control node from one or more network slice access control nodes, a first notification corresponding to a number of Protocol Data Unit, PDU, sessions in association with a network slice, wherein the first notification indicates the network slice is overloaded; and releasing, by the first policy control node, one or more of the PDU sessions of the network slice in response to the network slice being overloaded.

Various embodiments may preferably implement the following features:

Preferably, the one or more of the PDU sessions are released in response to all applications relating to the network slice being terminated or one or more critical applications relating to the network slice being terminated.

Preferably, the first notification is received in response to reaching a threshold corresponding to the number of the PDU sessions in association with the network slice.

Preferably, the method further comprises: transmitting, by the first policy control node to the one or more network slice access control nodes, a first subscription request for the number of the PDU sessions in association with the network slice.

Preferably, the first subscription request comprises a threshold of the number of the PDU sessions in association with the network slice.

Preferably, the method further comprises: receiving, by the first policy control node from a session management node, a request comprising information of one of the network slice access control nodes corresponding to one of the PDU sessions.

The present disclosure relates to a wireless communication method comprising: receiving, by a second policy control node from one or more network slice access control nodes, a second notification corresponding to a number of user equipments in association with a network slice; and releasing, by the first policy control node, one or more of the user equipments in association with the network slice from the network slice in response to the network slice being overloaded.

Various embodiments may preferably implement the following features:

Preferably, the one or more of the user equipments are released from the network slice in response to all applications relating to the network slice being terminated or one or more critical applications relating to the network slice being terminated.

Preferably, the one or more of the user equipments are released from the network slice through update allowed NSSAI or a user equipment route selection policy, URSP, update procedure.

Preferably, the second notification is received in response to reaching a threshold corresponding to the number of the user equipments in association with the network slice.

Preferably, the method further comprises: transmitting, by the second policy control node to the one or more network slice access control nodes, a second subscription request for the number of the user equipments in association with the network slice.

Preferably, the second subscription request comprises a threshold of the number of the user equipments in association with the network slice.

Preferably, the method further comprises: receiving, by the second policy control node from an access and management node, a request comprising information of one of the network slice access control nodes corresponding to one of the user equipments.

The present disclosure relates to a wireless communication method comprising: transmitting, by a network slice access control node, a first notification corresponding to a number of Protocol Data Unit, PDU, sessions in association with a network slice to a first policy control node; wherein the first notification is transmitted to allow the first policy control node to release one or more of the PDU sessions of the network slice in response to the network slice being overloaded.

Various embodiments may preferably implement the following features:

Preferably, the method further comprises: receiving, by the network slice access control node from the first policy control node, a first subscription request for the number of the PDU sessions in association with the network slice.

Preferably, the first subscription request comprises a threshold of the number of the PDU sessions in association with the network slice, and the first notification is transmitted when the threshold corresponding to the number of the PDU sessions in association with the network slice is reached.

The present disclosure relates to a wireless communication method comprising: transmitting, by a network slice access control node, at least one of: a second notification corresponding to a number of user equipments in association with a network slice to a second policy control node; wherein the second notification is transmitted to allow the second policy control node to release one or more of the user equipments in association with the network slice from the network slice in response to the network slice being overloaded.

Various embodiments may preferably implement the following features:

Preferably, the method further comprises: receiving, by the network slice access control node from the second policy control node, a second subscription request for the number of the user equipments in association with the network slice.

Preferably, the second subscription request comprises a threshold of the number of the user equipments in association with the network slice, and the second notification is transmitted when the threshold corresponding to the number of the user equipments in association with the network slice is reached.

The present disclosure relates to a wireless communication method comprising: removing, by an access and management node, Single Network Slice Selection Assistance Information, S-NSSAI, from an allowed Network Slice Selection Assistance Information, NSSAI, in a user equipment context of a user equipment, in response to a network slice of the S-NSSAI being overloaded.

Various embodiments may preferably implement the following features:

Preferably, the S-NSSAI is removed from the allowed NSSAI in response to the user equipment having no Protocol Data Unit, PDU, sessions in association with the network slice of the S-NSSAI.

Preferably, the S-NSSAI is removed from the allowed NSSAI in response to an expiration of a timer.

Preferably, the network slice of the S-NSSAI is determined to be overloaded based on at least one of: a maximum number of user equipments in associated with the network slice of the S-NSSAI, a setting from a network data analytics function, NWDAF, or a setting from an Operations, Administration, and Maintenance, OAM, node.

Preferably, the method further comprises: transmitting, by the access and management node to a policy control node, an updating message to update allowed NSSAI corresponding to the network slice stored in the policy control node in response to the S-NSSAI being removed.

Preferably, the method further comprises: receiving, by the access and management node from a policy control node, an unsubscribe request corresponding to the removed S-NSSAI.

The present disclosure relates to a wireless communication method comprising: receiving, by a policy control node from an access and management node, an updating message to update allowed Network Slice Selection Assistance Information, NSSAI, corresponding to a network slice stored in the policy control node, wherein the updating message is received in responding to Single Network Slice Selection Assistance Information, S-NSSAI, being removed from an allowed NSSAI in a user equipment context.

Various embodiments may preferably implement the following features:

Preferably, the method further comprises: transmitting, by the policy control node to the access and management node, an unsubscribe request to unsubscribe a slice status of the removed S-NSSAI.

Another aspect of the present disclosure relates to a wireless communication node. In an embodiment, the wireless communication node includes a communication unit and a processor. The communication unit is configured to receive, from one or more network slice access control nodes, a first notification corresponding to a number of Protocol Data Unit, PDU, sessions in association with a network slice, wherein the first notification indicates the network slice is overloaded. The processor is configured to release one or more of the PDU sessions of the network slice in response to the network slice being overloaded.

Another aspect of the present disclosure relates to a wireless communication node. In an embodiment, the wireless communication node includes a communication unit and a processor. The communication unit is configured to receive, from one or more network slice access control nodes, a second notification corresponding to a number of user equipments in association with a network slice. The processor is configured to release one or more of the user equipments in association with the network slice from the network slice in response to the network slice being overloaded.

Another aspect of the present disclosure relates to a wireless communication node. In an embodiment, the wireless communication node includes a communication unit. The communication unit is configured to transmit a first notification corresponding to a number of Protocol Data Unit, PDU, sessions in association with a network slice to a first policy control node; wherein the first notification is transmitted to allow the first policy control node to release one or more of the PDU sessions of the network slice in response to the network slice being overloaded.

Another aspect of the present disclosure relates to a wireless communication node. In an embodiment, the wireless communication node includes a communication unit. The communication unit is configured to transmit a second notification corresponding to a number of user equipments in association with a network slice to a second policy control node; wherein the second notification is transmitted to allow the second policy control node to release one or more of the user equipments in association with the network slice from the network slice in response to the network slice being overloaded.

Another aspect of the present disclosure relates to a wireless communication node. In an embodiment, the wireless communication node includes a processor. The processor is configured to remove Single Network Slice Selection Assistance Information, S-NSSAI, from an allowed Network Slice Selection Assistance Information, NSSAI, in a user equipment context of a user equipment, in response to a network slice of the S-NSSAI being overloaded.

Another aspect of the present disclosure relates to a wireless communication node. In an embodiment, the wireless communication node includes a communication unit. The communication unit is configured to receive, by a policy control node from an access and management node, an updating message to update allowed Network Slice Selection Assistance Information, NSSAI, corresponding to a network slice stored in the policy control node, wherein the updating message is received in responding to Single Network Slice Selection Assistance Information, S-NSSAI, being removed from an allowed NSSAI in a user equipment context.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

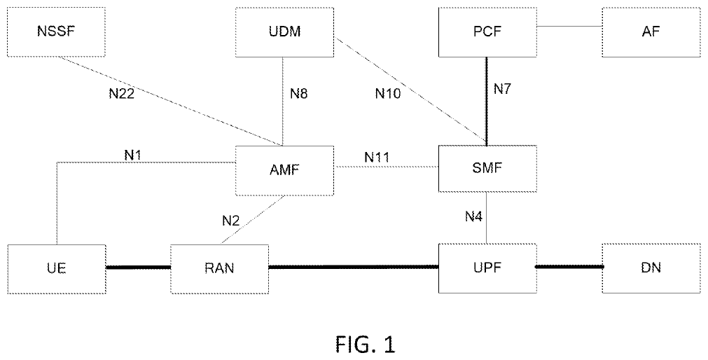

FIG. 1 shows a schematic diagram of a network according to an embodiment of the present disclosure.

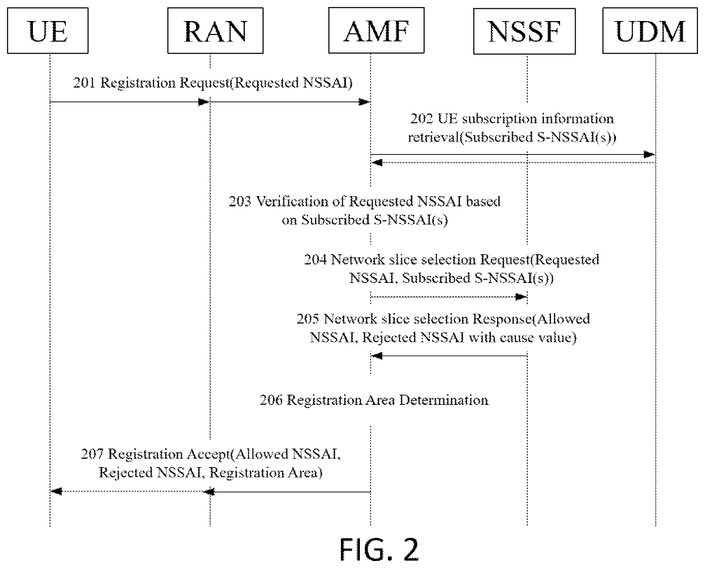

FIG. 2 shows a schematic diagram of a procedure according to an embodiment of the present disclosure.

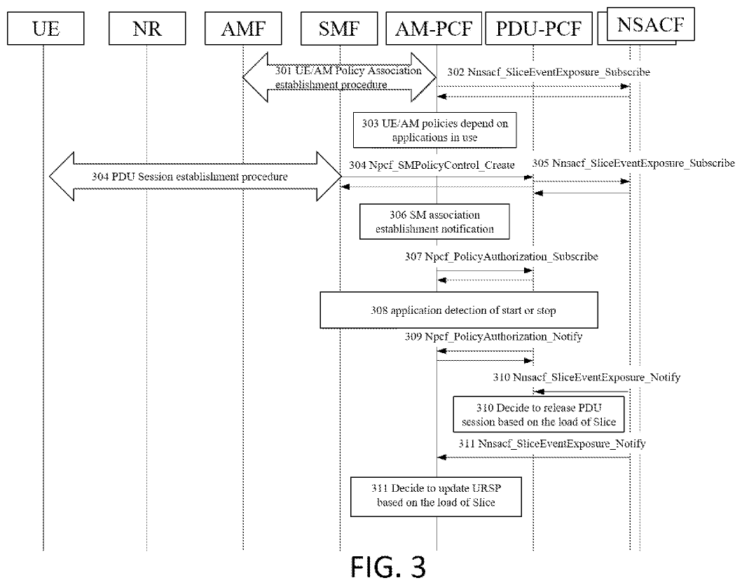

FIG. 3 shows a schematic diagram of a procedure according to an embodiment of the present disclosure.

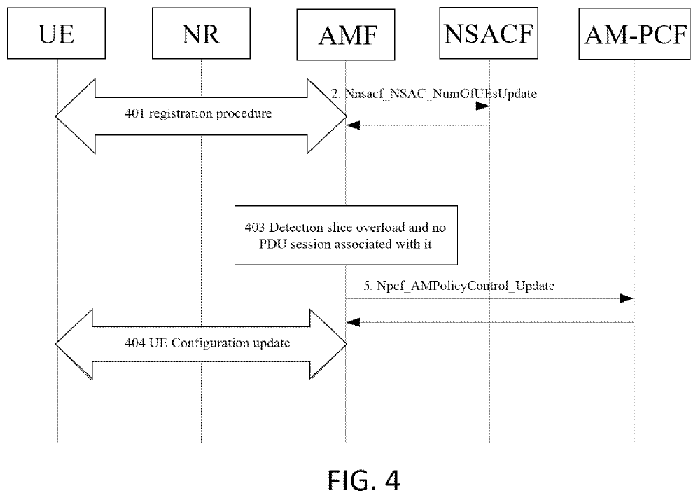

FIG. 4 shows a schematic diagram of a procedure according to an embodiment of the present disclosure.

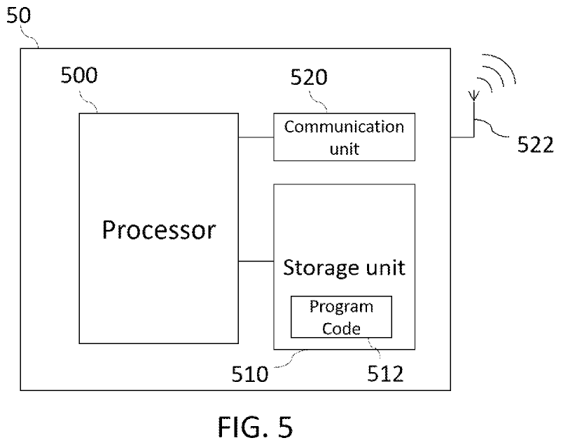

FIG. 5 shows an example of a schematic diagram of a wireless terminal according to an embodiment of the present disclosure.

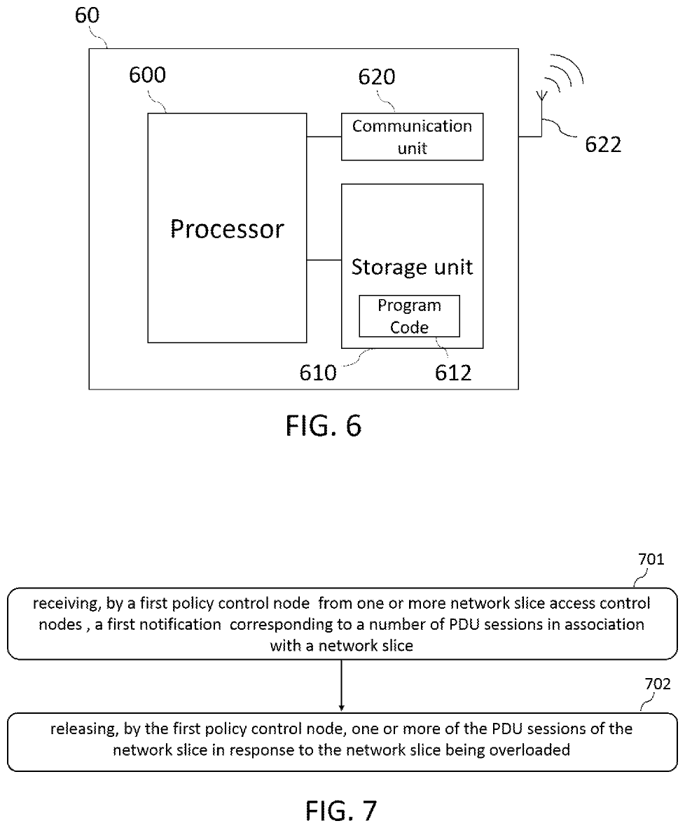

FIG. 6 shows an example of a schematic diagram of a wireless network node according to an embodiment of the present disclosure.

FIGS. 7 to 12 show flowcharts of methods according to embodiments of the present disclosure.

FIG. 1 shows a schematic diagram of a network (architecture) according to an embodiment of the present disclosure. In FIG. 1, the network (architecture) may comprise any of the following network functions (NFs).

In an embodiment, the network (architecture) comprises a User Equipment (UE), a Radio Access Network (RAN), and an Access and Mobility Management Function (AMF). The AMF NF includes functionalities such as UE Mobility Management, Reachability Management, Connection Management and Registration Management. The AMF terminates the RAN control plane (CP) interface N2 and Non-Access Stratum (NAS) interface N1, NAS ciphering and integrity protection. It also distributes the Session Management (SM) NAS to the proper Session Management Functions (SMFs) via N11 interface.

During Registration procedure, the AMF may determine the allowed NSSAI, the rejected NSSAI with rejection cause based on the requested NSSAI received from the UE. The AMF further determines the Registration Area within which the UE can use all S-NSSAIs of the allowed NSSAI. The AMF sends the allowed NSSAI, the rejected NSSAI with rejection cause and the Registration Area to the UE.

In an embodiment, the network (architecture) further comprises a Unified Data Management (UDM). The UDM manages the subscription profile for the UEs. The subscription data is stored in the Unified Data Repository (UDR). The subscription information includes the data used for Mobility Management and Session Management. The AMF and SMF retrieve the subscription data from the UDM.

In an embodiment, the network (architecture) further comprises Network Slice Selection Function (NSSF). The NSSF supports the following functionalities: selecting the set of Network Slice instances serving the UE; determining the allowed NSSAI and, if needed, the mapping to the Home Public Land Mobile Network (HPLMN) S-NSSAIs; determining the configured Network Slice Selection Assistant Information (NSSAI) and, if needed, the mapping to the HPLMN Single-Network Slice Selection Assistant Information (S-NSSAI); determining the AMF Set to be used to serve the UE, or, based on configuration, a list of candidate AMF(s), possibly by querying the Network Repository Function (NRF).

In the case of home-routed roaming, there may be two main options dependent on the operators' choices in terms of involvement of NRF, NSSF and configuration of AMF. One option is that HPLMN and Visitor Public Land Mobile Network (VPLMN) deploy the NSSF separately (called vNSSF and hNSSF).

In an embodiment, the network (architecture) further comprises a Session Management Function (SMF). The SMF includes the following functionalities: session establishment, modification and release, UE IP address allocation and management, selection and control of user plane (UP) function, etc.

In an embodiment, the network (architecture) further comprises a User Plane Function (UPF). The UPF serves as an anchor point for intra-/inter-radio access technology (RAT) mobility and as the external PDU session point of interconnect to the Data Network (DN). The UPF also routes and forwards the data packet according to the indication from the SMF. It also buffers the downlink (DL) data when the UE is in idle mode.

In an embodiment, the network (architecture) further comprises an Application Function (AF). The AF interacts with the 3GPP Core Network in order to provide services, for example to support application influence on traffic routing, accessing NEF, interacting with the policy framework for policy control, etc.

In an embodiment, the network (architecture) further comprises a Policy Control Function (PCF). The PCF supports unified policy framework to govern network behavior. The PCF provides access management policy to AMF, or session management policy to SMF, or UE policy to the UE. The PCF can access the UDR to obtain the subscription information relevant for policy decisions.

FIG. 2 shows a schematic diagram of a procedure according to an embodiment of the present disclosure. In this embodiment, a UE registration procedure to s set of Network Slices is shown. Specifically, the procedure shown in FIG. 2 comprises:

Step 201: When a UE registers over an Access Type with a PLMN, the UE may provide to the network in NAS layer, a Requested NSSAI containing the S-NSSAI(s) corresponding to the slice(s) to which the UE wishes to register.

The Requested NSSAI may be any one of:
The Default Configured NSSAI, i.e. if the UE has no configured NSSAI nor an allowed NSSAI for the serving PLMN;
The configured-NSSAI, or a subset thereof, e.g. if the UE has no Allowed NSSAI for the Access Type for the serving PLMN;
The allowed-NSSAI for the Access Type over which the requested NSSAI is sent, or a subset thereof; or
The allowed-NSSAI for the Access Type over which the requested NSSAI is sent, or a subset thereof, plus one or more S-NSSAIs from the configured-NSSAI not yet in the allowed NSSAI for the Access Type.

Step 202: When the AMF selected by the RAN during the registration procedure receives the UE registration request, the AMF may query the UDM to retrieve UE subscription information including the subscribed S-NSSAIs.

Step 203: The AMF verifies whether the S-NSSAI(s) in the requested NSSAI are permitted based on the subscribed S-NSSAIs. To identify the subscribed S-NSSAIs, the AMF may use the mapped HPLMN S-NSSAIs provided by the UE in the NAS message, for each S-NSSAI of the requested NSSAI.

Step 204: When the UE context in the AMF does not yet include an allowed NSSAI for the corresponding Access Type, the AMF queries the NSSF for network slice selection, except in the case when the AMF is allowed to determine whether it can serve the UE based on a configuration in this AMF. The IP address or FQDN of the NSSF is locally configured in the AMF.

Step 205: The NSSF returns to the AMF the allowed NSSAI. It may also return the rejected S-NSSAI(s) with rejection cause indicating the reason why the S-NSSAI(s) has been rejected, e.g., rejected NSSAI for the current PLMN, rejected NSSAI for the current registration area, etc.

Step 206: The serving AMF may determine a registration area such that all S-NSSAIs in the allowed NSSAI are available in all tracking areas of the registration area.

Step 207: The AMF sends a registration accept message to the UE including the allowed NSSAI and the mapped HPLMN NSSAI of the allowed NSSAI if provided, the rejected S-NSSAI(s) with rejection cause and the registration area.

After completion of the registration procedure, the UE may request to establish a PDU session. The requested S-NSSAI of the PDU session is derived from the URSP rules or UE local configuration. The requested S-NSSAI may be within the allowed NSSAI.

In an embodiment, methods are provided to ensure that the resource of a respective slice will be released or re-evaluated in time in case that:
a) all applications transferred via the PDU session are terminated or some critical applications are terminated; or
b) the network is congested, e.g. the maximum number of UEs registered on the S-NSSAI is reached or maximum number of PDU sessions established on the S-NSSAI is reached.

FIG. 3 shows a schematic diagram of a procedure according to an embodiment of the present disclosure. In this embodiment, a UE registration procedure to s set of Network Slices is shown. In this embodiment, the NSACF for the number of UEs or the number of PDU sessions per network slice may be the same or different.

In the non roaming case, the AMF selects a PCF instance for AM policy association and selects the same PCF instance for UE policy association. In the roaming case, the AMF selects a V-PCF instance for AM policy association and selects the same V-PCF instance for UE policy association.

Specifically, the procedure shown in FIG. 3 comprises:

Step 301: The UE registers to the network and retrieves the allowed NSSAI. During the registration procedure, the AMF establishes AM Policy Association with the (V-)PCF by sending Npcf_AMPolicyControl_Create to the (V-)PCF. If NSACF is deployed for slice admission control, the message includes the allowed NSSAI and the associated NSACF. If multiple NSACFs are deployed in a network and one NSACF may be responsible for one or more S-NSSAIs in a service area, an S-NSSAI included in the allowed NSSAI may be associated with several NSACFs. The PCF maintains relationship of the UE, the S-NSSAI and NSACF(s). The PCF selected by the AMF for the AM Policy Association is referred to as AM-PCF and/or UE-PCF in the following description and respective figures.

Step 302: To subscribe or unsubscribe for the number of UEs per network slice notification with the NSACF, the PCF sends a Nnsacf_SliceEventExposure_Subscribe/Unsubscribe Request to the NSACF. The PCF can decide to subscribe one or more S-NSSAIs included in allowed NSSAI. If multiple NSACFs are deployed in a network for one S-NSSAI in a service area, the PCF may send more than one subscribe request to those NSACFs to retrieve slice status. The PCF can set the threshold in the request. When the threshold is reached, the NSACF sends a notification to the PCF. In an embodiment, based on the implementation, after the NSACF sends the notification to the PCF, if the load is below the threshold in a pre-configured time, the NSACF may send another notification to indicate that the corresponding network slice doesn't overload any more.

Step 303: If the AM Policy depends on the application in use, then depending on operator policies in the PCF, the PCF may subscribe to BSF or provides its PCF binding information to the AMF with the indication to be notified about the PCF for a PDU Session for a DNN, S-NSSAI.

Step 304: During the PDU session establishment procedure, the SMF establishes a SM Policy Association. The allocated UE address/prefix, SUPI, DNN, S-NSSAI and the PCF address is registered in the BSF.

The SMF determines that the PCC authorization is required and requests to establish an SM Policy Association with the PCF by invoking Npcf_SMPolicyControl_Create operation. The SMF provides the request for notification of SM Policy Association establishment and termination to a DNN, S-NSSAI together with AM-PCF binding information to the SM-PCF if received from the AMF. The PCF selected by the SMF for the SM Policy Association is referred to as SMF-PCF or PDU-PCF in the following description and/or respective figures.

If NSACF is deployed for slice admission control, the message includes the S-NSSAI with the associated NSACF. If multiple NSACFs are deployed in a network and one NSACF may be responsible for one or more S-NSSAIs in a service area, the S-NSSAI may be associated with several NSACFs. Npcf_SMPolicyControl_Create operation includes the NSACF for the PDU session (associated with the DNN and S-NSSAI). The PCF maintains relationship between the PDU session for the application, the S-NSSAI and NSACF(s).

Step 305: To subscribe or unsubscribe for the number of the PDU sessions per network slice notification with the NSACF, the PCF sends the Nnsacf_SliceEventExposure_Subscribe/Unsubscribe Request to the NSACF. The PCF decides to subscribe the S-NSSAI of the PDU session. If multiple NSACFs are deployed in a network for one S-NSSAI in a service area, the PCF may send more than one subscribe request to those NSACFs to retrieve slice status. The PCF can set the threshold in the request. When the threshold is reached, the NSACF sends a notification to the PCF. In an embodiment, based on the implementation, after the NSACF sends the notification to the PCF, if the load is below the threshold in a pre-configured time, the NSACF may send another notification to indicate that the corresponding network slice does not overload anymore.

Step 306: If the AM-PCF is subscribed to BSF, then the BSF notifies that a PCF for the PDU Session is registered in the BSF, by invoking Nbsf_Management_Notify to the AM-PCF. When there are multiple PDU Sessions to the same (DNN, S-NSSAI) the BSF provides multiple notifications to the PCF.

If the AM-PCF sends the request to notify that a PCF for the PDU Session is available to the AMF, then the PCF for the PDU Sessions sends Npcf_PolicyAuthorization_Notify to the AM-PCF.

Step 307: The AM-PCF subscribes to notifications of event “start/stop of application traffic” by sending Npcf_PolicyAuthorization_Subscribe (UE address, EventId, EventFilter set to “list of Application Identifiers”) to the SM-PCF. The SM-PCF for the PDU Session then generates PCC Rules including the Application Identifier in the SDF template, if there are multiple Application Identifiers included in the Npcf_PolicyAuthorization, the PCF generates PCC Rules for each Application Identifier.

Step 308: The SM-PCF installs PCC Rules and the Policy Control Request Trigger to detect “start/stop of application traffic” in the SMF.

The SMF detects that the Policy Control Request Trigger is met, then reports the start/stop of application traffic to the PCF serving the PDU session.

Step 309: The AM-PCF is notified on the start/stop of application traffic by Npcf_PolicyAuthorization_Notify. When the reporting of start and stop of a list of application(s) was requested, the PCF for the PDU Session provides multiple notifications to the AM-PCF.

Step 310: If the threshold is reached, the NSACF for a number of PDU sessions per network slice sends a notification to the SM-PCF.

If all applications or some critical applications related with the overloaded slice have stopped and the load threshold has been reached, the PCF can initiate the release of the associated PDU Session.

Step 311: If the threshold is reached, the NSACF for a number of UEs per network slice sends a notification to the AM-PCF.

If all applications or some critical applications related with the overloaded slice have stopped and the load threshold has been reached, the PCF can initiate the URSP update procedure to the UE or trigger the AMF to update the allowed NSSAI. If the PCF triggers the AMF to update the allowed NSSAI, the PCF may inform the AMF of the overloaded S-NSSAI or send updated allowed NSSAI to the AMF which doesn't include the overloaded S-NSSAI. When the AMF receives the notification from the PCF, the AMF triggers the User Configuration Update procedure to send the updated allowed NSSAI to the UE, which doesn't include the overloaded S-NSSAI.

FIG. 4 shows a schematic diagram of a procedure according to an embodiment of the present disclosure. Specifically, the procedure shown in FIG. 4 comprises:

Step 401: The UE registers to the network and retrieves the allowed NSSAI. During the registration procedure, the AMF establishes AM Policy Association with the (V-)PCF by sending Npcf_AMPolicyControl_Create to the (V-)PCF. The allowed NSSAI is sent to the PCF.

Step 402: If EAC mode is activated, the AMF performs NSAC before the allowed NSSAI is sent to the UE included in the registration accept message. If EAC mode is deactivated, the AMF performs NSAC after the registration completion. The NSACF updates the current number of UEs registered for the S-NSSAI, i.e. increases or decrease the number of UEs registered per network slice based on the information provided by the AMF in the update flag parameter. This step is performed if NSACF is deployed.

Step 403: If NSACF is deployed and the NSACF returns S-NSSAI(s) with result parameters indicating the maximum number of UEs per network slice has already been reached. The AMF can be deemed overloaded upon reception of one response with such result for an S-NSSAI. The AMF can also use some statistical methods to decide on the overload. For example, based on the number of responses with such result in a certain period of time.

If NSACF is not deployed, the AMF can detect overload via interaction with NWDAF or OAM setting.

When AMF detects overload of an S-NSSAI, the AMF can check the UE contexts in which the allowed NSSAI includes such overloaded S-NSSAI. If the allowed NSSAI of a UE includes such overloaded S-NSSAI and there is no PDU session associated with such S-NSSAI, the AMF can remove the S-NSSAI from the allowed NSSAI immediately, or start a timer. Then if the timer expires, the AMF removes the S-NSSAI from the allowed NSSAI.

Step 404: If the AMF decides to remove the overloaded S-NSSAI from the allowed NSSAI, the AMF initiates the UE configuration update procedure to the UE to update the allowed NSSAI. If NSACF is deployed, the AMF also sends a Nnsacf_NSAC_NumOfUEsUpdate_Request message to the NSACF to decrease the number of UEs registered per network slice. The AMF can perform such check only for some (not all) registered UEs. When such S-NSSAI is removed from the allowed NSSAIs of some registered UEs, the number of UEs registered in the network slice is decreased and thus the load of the network slice is also decreased. The UE selection depends on implementation, e.g. the polling algorithm.

Step 405: The AMF updates the allowed NSSAI in AM-PCF by sending Npcf_AMPolicyControl_Update. If the PCF has subscribed the slice status of removed allowed S-NSSAI, the PCF unsubscribes the status by sending Nnsacf_SliceEventExposure_Unsubscribe to the NSACF.

In an embodiment, when a NF detects the overload of a network slice, it initiates the network slice release procedure.

In this embodiment, the AMF/SMF sends NSACF information to the AM-PCF/SM-PCF. PCF subscribes the slice status. If the slice is overloaded and the application(s) associated with such slices are terminated, the PCF can decide to release the PDU session or URSP update to release the using of such slices.

In this embodiment, the AMF detects the overloade of a network slice and checks whether resources of such slices are used by the UE (whether there is any PDU session associated with such S-NSSAI). The AMF removes such S-NSSAI from the allowed NSSAI if it is not used by the UE.

In this disclosure, a network slice relates to a logical network that provides specific network capabilities and network characteristics.

In this disclosure, a network slice instance relates to a set of Network Function (NF) instance and the required resources (e.g. compute, storage and networking resources) which form a deployed network slice.

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g. messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g. a base station).

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g. messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g. a user equipment or another wireless network node).

FIG. 7 shows a flowchart of a method according to an embodiment of the present disclosure. The method shown in FIG. 7 may be used in a PDU-PCF (e.g. wireless network node/wireless device comprising the PDU-PCF or wireless network node/wireless device performing at least part of functionalities of the PDU-PCF) and comprises:

Step 701: Receiving, by a first policy control node (e.g. PDU-PCF) from one or more network slice access control nodes (e.g. NASCF), a first notification (e.g., the notification in Step 310 described above) corresponding to a number of PDU sessions in association with a network slice.

Step 702: Releasing, by the first policy control node, one or more of the PDU sessions of the network slice in response to the network slice being overloaded.

In this embodiment, the first notification indicates that the network slice is overloaded.

In an embodiment, the one or more of the PDU sessions are released in response to all applications relating to the network slice being terminated or one or more critical applications relating to the network slice being terminated.

In an embodiment, the first notification is received in response to reaching a threshold corresponding to the number of the PDU sessions in association with the network slice.

In an embodiment, the method further comprises: transmitting, by the first policy control node to the one or more network slice access control nodes, a first subscription request for the number of the PDU sessions in association with the network slice.

In an embodiment, the first subscription request comprises a threshold of the number of the PDU sessions in association with the network slice.

In an embodiment, the method further comprises: receiving, by the first policy control node from a session management node (e.g. SMF), a request comprising information of one of the network slice access control nodes corresponding to one of the PDU sessions.

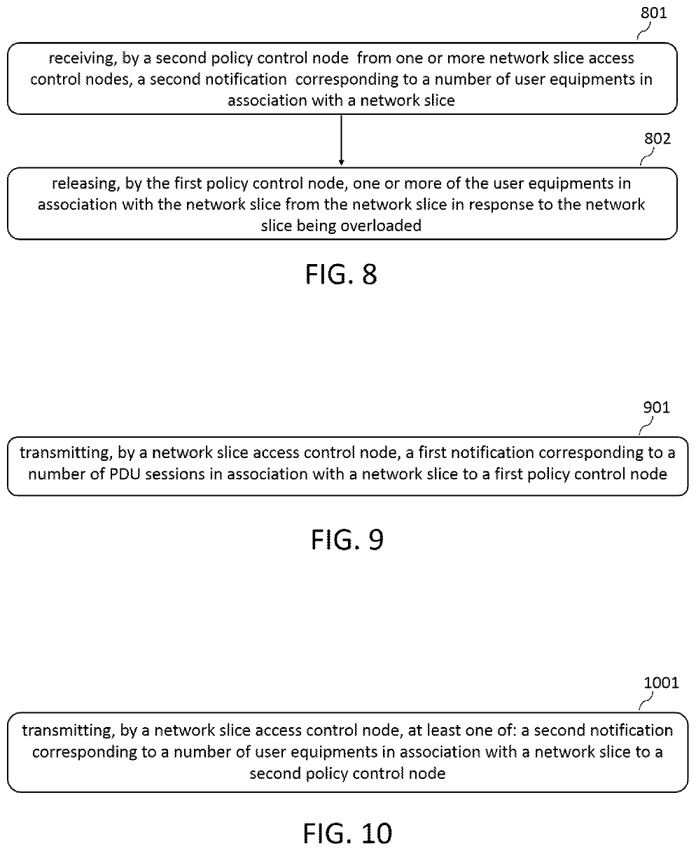

FIG. 8 shows a flowchart of a method according to an embodiment of the present disclosure. The method shown in FIG. 8 may be used in an AM-PCF (e.g. wireless network node/wireless device comprising the AM-PCF or wireless network node/wireless device performing at least part of functionalities of the AM-PCF) and comprises:

Step 801: Receiving, by a second policy control node (e.g. AM-PCF) from one or more network slice access control nodes, a second notification (e.g., the notification in Step 311 described above) corresponding to a number of user equipments in association with a network slice.

Step 802: Releasing, by the first policy control node, one or more of the user equipments in association with the network slice from the network slice in response to the network slice being overloaded.

In an embodiment, the one or more of the user equipments are released from the network slice in response to all applications relating to the network slice being terminated or one or more critical applications relating to the network slice being terminated.

In an embodiment, the one or more of the user equipments are released from the network slice through update allowed NSSAI or a user equipment route selection policy, URSP, update procedure.

In an embodiment, the second notification is received in response to reaching a threshold corresponding to the number of the user equipments in association with the network slice.

In an embodiment, the method further comprises: transmitting, by the second policy control node to the one or more network slice access control nodes, a second subscription request for the number of the user equipments in association with the network slice.

In an embodiment, the second subscription request comprises a threshold of the number of the user equipments in association with the network slice.

In an embodiment, the method further comprises: receiving, by the second policy control node from an access and management node (e.g. AMF), a request comprising information of one of the network slice access control nodes corresponding to one of the user equipments.

FIG. 9 shows a flowchart of a method according to an embodiment of the present disclosure. The method shown in FIG. 9 may be used in an NSACF (e.g. wireless network node/wireless device comprising the NSACF or wireless network node/wireless device performing at least part of functionalities of the NSACF) and comprises:

Step 901: Transmitting, by a network slice access control node (e.g. NSACF), a first notification (e.g., the notification in Step 310 described above) corresponding to a number of PDU sessions in association with a network slice to a first policy control node.

In this embodiment, the first notification is transmitted to allow the first policy control node to release one or more of the PDU sessions of the network slice in response to the network slice being overloaded.

In an embodiment, the method further comprises: receiving, by the network slice access control node from the first policy control node, a first subscription request for the number of the PDU sessions in association with the network slice.

In an embodiment, the first subscription request comprises a threshold of the number of the PDU sessions in association with the network slice, and the first notification is transmitted when the threshold corresponding to the number of the PDU sessions in association with the network slice is reached.

FIG. 10 shows a flowchart of a method according to an embodiment of the present disclosure. The method shown in FIG. 10 may be used in an NSACF (e.g. wireless network node/wireless device comprising the NSACF or wireless network node/wireless device performing at least part of functionalities of the NSACF) and comprises:

Step 1001: Transmitting, by a network slice access control node, at least one of: a second notification (e.g., the notification in Step 311 described above) corresponding to a number of user equipments in association with a network slice to a second policy control node.

In this embodiment, the second notification is transmitted to allow the second policy control node to release one or more of the user equipments in association with the network slice from the network slice in response to the network slice being overloaded.

In an embodiment, the method further comprises: receiving, by the network slice access control node from the second policy control node, a second subscription request for the number of the user equipments in association with the network slice.

In an embodiment, the second subscription request comprises a threshold of the number of the user equipments in association with the network slice, and the second notification is transmitted when the threshold corresponding to the number of the user equipments in association with the network slice is reached.

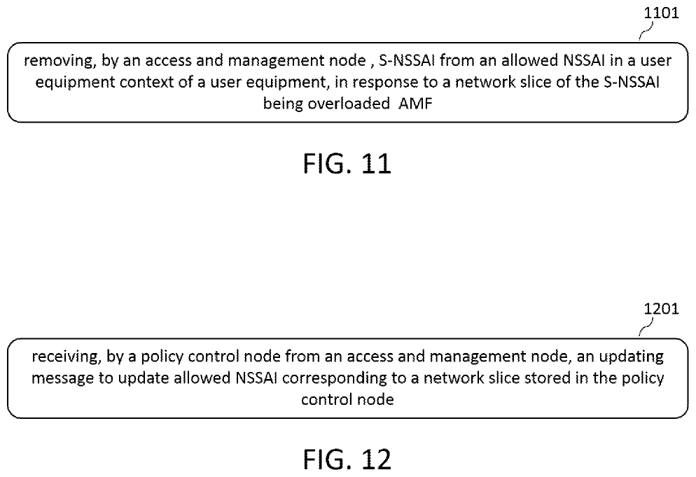

FIG. 11 shows a flowchart of a method according to an embodiment of the present disclosure. The method shown in FIG. 11 may be used in an AMF (e.g. wireless network node/wireless device comprising the AMF or wireless network node/wireless device performing at least part of functionalities of the AMF) and comprises:

Step 1101: removing, by an access and management node (e.g. AMF), S-NSSAI from an allowed NSSAI in a user equipment context of a user equipment, in response to a network slice of the S-NSSAI being overloaded.

In an embodiment, the S-NSSAI is removed from the allowed NSSAI in response to the user equipment having no Protocol Data Unit, PDU, sessions in association with the network slice of the S-NSSAI.

In an embodiment, the S-NSSAI is removed from the allowed NSSAI in response to an expiration of a timer.

In an embodiment, the network slice of the S-NSSAI is determined to be overloaded based on at least one of: a maximum number of user equipments in associated with the network slice of the S-NSSAI, a setting from a network data analytics function, NWDAF, or a setting from an Operations, Administration, and Maintenance, OAM, node.

In an embodiment, the method further comprises: transmitting, by the access and management node to a policy control node (e.g. AM-PCF), an updating message to update allowed NSSAI corresponding to the network slice stored in the policy control node in response to the S-NSSAI being removed.

In an embodiment, the method further comprises: receiving, by the access and management node from a policy control node, an unsubscribe request corresponding to the removed S-NSSAI.

FIG. 12 shows a flowchart of a method according to an embodiment of the present disclosure. The method shown in FIG. 12 may be used in an AM-PCF (e.g. wireless network node/wireless device comprising the AM-PCF or wireless network node/wireless device performing at least part of functionalities of the AM-PCF) and comprises:

Step 1101: Receiving, by a policy control node (e.g. AM-PCF) from an access and management node, an updating message to update allowed NSSAI corresponding to a network slice stored in the policy control node.

In this embodiment, the updating message is received in responding to S-NSSAI being removed from an allowed NSSAI in a user equipment context.

In an embodiment, the method further comprises: transmitting, by the policy control node to the access and management node, an unsubscribe request to unsubscribe a slice status of the removed S-NSSAI.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a first policy control node from one or more network slice access control nodes, a first notification corresponding to a number of Protocol Data Unit, PDU, sessions in association with a network slice, wherein the first notification indicates the network slice is overloaded; and
releasing, by the first policy control node, one or more of the PDU sessions of the network slice in response to the network slice being overloaded.

2. The wireless communication method of claim 1, wherein the one or more of the PDU sessions are released in response to all applications relating to the network slice being terminated or one or more critical applications relating to the network slice being terminated.

3. The wireless communication method of claim 1, wherein the first notification is received in response to reaching a threshold corresponding to the number of the PDU sessions in association with the network slice.

4. The wireless communication method of claim 1, further comprising:
transmitting, by the first policy control node to the one or more network slice access control nodes, a first subscription request for the number of the PDU sessions in association with the network slice.

5. The wireless communication method of claim 4, wherein the first subscription request comprises a threshold of the number of the PDU sessions in association with the network slice.

6. The wireless communication method of claim 1, further comprising:
receiving, by the first policy control node from a session management node, a request comprising information of one of the network slice access control nodes corresponding to one of the PDU sessions.

7. A wireless communication method comprising:
receiving, by a second policy control node from one or more network slice access control nodes, a second notification corresponding to a number of user equipments in association with a network slice; and
releasing, by the first policy control node, one or more of the user equipments in association with the network slice from the network slice in response to the network slice being overloaded.

8. The wireless communication method of claim 7, wherein the one or more of the user equipments are released from the network slice in response to all applications relating to the network slice being terminated or one or more critical applications relating to the network slice being terminated.

9. The wireless communication method of claim 7, wherein the one or more of the user equipments are released from the network slice through update allowed NSSAI or a user equipment route selection policy, URSP, update procedure.

10. The wireless communication method of claim 7, wherein the second notification is received in response to reaching a threshold corresponding to the number of the user equipments in association with the network slice.

11. The wireless communication method of claim 7, further comprising:
transmitting, by the second policy control node to the one or more network slice access control nodes, a second subscription request for the number of the user equipments in association with the network slice.

12. The wireless communication method of claim 11, wherein the second subscription request comprises a threshold of the number of the user equipments in association with the network slice.

13. The wireless communication method of claim 7, further comprising:
receiving, by the second policy control node from an access and management node, a request comprising information of one of the network slice access control nodes corresponding to one of the user equipments.

14. A wireless communication method comprising:
transmitting, by a network slice access control node, a first notification corresponding to a number of Protocol Data Unit, PDU, sessions in association with a network slice to a first policy control node;
wherein the first notification is transmitted to allow the first policy control node to release one or more of the PDU sessions of the network slice in response to the network slice being overloaded.

15. The wireless communication method claim 14, further comprising:
receiving, by the network slice access control node from the first policy control node, a first subscription request for the number of the PDU sessions in association with the network slice.

16. The wireless communication method of claim 15, wherein the first subscription request comprises a threshold of the number of the PDU sessions in association with the network slice, and the first notification is transmitted when the threshold corresponding to the number of the PDU sessions in association with the network slice is reached.

17-40. (canceled)
